(19) United States
(12) Patent Application Publication
(10) Pub. No.: US 2017/0097743 A1
(43) Pub. Date: Apr. 6, 2017

(54) Recommending Applications

(71) Applicant: Quixey, Inc., Mountain View, CA (US)

(72) Inventors: Yaser Hameed, Bengaluru (IN); Jithin Justin, Kottayam (IN); Eric J. Glover, Palo Alto, CA (US)

(73) Assignee: Quixey, Inc., Mountain View, CA (US)

(21) Appl. No.: 14/874,769

(22) Filed: Oct. 5, 2015

(51) Int. Cl. G06F 3/0482; G06F 17/22; G06F 3/14; G06F 3/0484

(52) U.S. Cl. CPC G06F 3/0482; G06F 3/04842; G06F 17/2235; G06F 3/14

(57) ABSTRACT

A method includes receiving, at data processing hardware, usage data of a user interacting with a collection of applications associated with the user. The method includes receiving an indication of a first user selection of a first application of the collection of applications on a screen in communication with the data processing hardware, and identifying one or more applications of the collection of applications as one or more recommended applications satisfying criteria for a second user selection subsequent and sequential to the first user selection on the screen. The method also includes displaying on the screen a user selectable link for each recommended application. Each user selectable link is associated with an application access mechanism that has a reference to the corresponding recommended application and that indicates a performable operation for the corresponding recommended application.

### TECHNICAL FIELD

This disclosure relates to a system for recommending applications on a user device.

### BACKGROUND

In recent years, use of computers, smartphones, and other Internet-connected devices has grown exponentially. Correspondingly, the number of available software applications for such devices has also grown. Today, many diverse native and web software applications can be accessed on any number of different devices, including, but not limited to, smartphones, personal computers, automobiles, and televisions. These diverse applications can range from business driven applications, games, educational applications, news applications, shopping applications, messaging applications, media streaming applications, social networking applications, and so much more. Furthermore, application developers develop vast amounts of applications within each genre and each application may have numerous editions.

### SUMMARY

One aspect of the disclosure provides a method for recommending one or more recommended applications from a collection of applications installed on a user device. The method includes receiving, at data processing hardware, usage data of the user interacting with a collection of applications associated with the user. The method includes receiving, at the data processing hardware, an indication of a first user selection of a first application of the collection of applications on a screen in communication with the data processing hardware. The method also includes identifying, by the data processing hardware, one or more applications of the collection of applications as one or more recommended applications satisfying criteria for a second user selection subsequent and sequential to the first user selection on the screen. The method also includes displaying on the screen, by the data processing hardware, a user selectable link for each identified recommended application. Each user selectable link is associated with an application access mechanism having a reference to the corresponding recommended application and indicating a performable operation for the corresponding recommended application.

Implementations of the disclosure may include one or more of the following optional features. In some implementations, the criteria for the second user selection includes having a threshold probability of the second user selection within a threshold period of time after the first user selection of the first application.

In some examples, the method also includes determining, by the data processing hardware, a probability of the second user selection of a second application of the collection of applications within the threshold period of time after receiving the indication of the first user selection of the first application. The method also includes identifying, by the data processing hardware, the second application as the recommended application when the probability of the second user selection of the second application satisfies the threshold probability.

The indication of the first user selection may indicate at least one of a selection of a representation associated with the first application on the screen or execution of the first application. In some examples, the criteria for the second user selection includes at least one of a time of day, a day of week, a location, a user device service status, a user device movement status, a device platform, or contextual information. Additionally, in some examples, the method may also include determining, by the processing hardware, user behavior patterns with respect to the collection of applications based on the criteria, and determining, by the processing hardware, a probability of the second user selection of a second application of the collection of applications based on the user behavior patterns after receiving the indication of the first user selection of the first application. The method may also include identifying, by the data processing hardware, the second application as a recommended application when the probability of the second user selection of the second application satisfies a probability criterion. The user behavior patterns may include at least one of selecting an application of the collection of applications or performing one or more operations on an application of the collection of applications. In some examples, the method also includes determining the probability of the second user selection of the second application of the collection of applications based on user behavior patterns of another user.

In some implementations, the method also includes receiving, at the data processing hardware, a user selection of one of the one or more user selectable links, and executing, at the data processing hardware, the application access mechanism associated with the selected user selectable link. The executed application access mechanism associated with the selected user selectable link may launch the corresponding recommended application and set the recommended application to an application state specified by the application access mechanism.

Another aspect of the disclosure provides a system for recommending one or more recommended applications from a collection of applications installed on a user device. The system includes data processing hardware and memory hardware. The memory hardware is in communication with the data processing hardware. The memory hardware stores instructions that when executed on the data processing hardware cause the data processing hardware to perform operations. The operations include receiving usage data of a user interacting with a collection of applications associated with the user, and receiving an indication of a first user selection of a first application of the collection of applications on a screen in communication with the data processing hardware. The operations also include identifying one or more applications of the collection of applications as one or more recommended applications satisfying criteria for a second user selection subsequent and sequential to the first user selection on the screen. The operations also include displaying on the screen a user selectable link for each identified recommended application. Each user selectable link is associated with an application access mechanism that has a reference to the corresponding recommended application and indicating a performable operation for the corresponding recommended application.

This aspect may include one or more of the following optional features. In some examples, the criteria for the second user selection includes having a threshold probability of the second user selection within a threshold period of time after the first user selection of the first application. The operations may further include determining a probability of the second user selection of a second application of the collection of applications within the threshold period of time after receiving the indication of the first user selection of the first application, and identifying the second application as a recommended application when the probability of the second user selection of the second application satisfies the threshold probability.

In some implementations, the indication of the first user selection indicates at least one of a selection of a representation associated with the first application on the screen or execution of the first application. The criteria for the second user selection comprises at least one of a time of day, a day of week, a location, a user device service status, a user device movement status, a device platform, or contextual information. The operations may also include determining user behavior patterns with respect to the collection of applications based on the criteria and determining a probability of the second user selection of a second application of the collection of applications based on the user behavior patterns after receiving the indication of the first user selection of the first application. The operations also include identifying the second application as a recommended application when the probability of the second user selection of the second application satisfies a probability criterion. The user behavior patterns include at least one of selecting an application of the collection of applications or performing one or more operations on an application of the collection of applications. In some examples, the operations further include determining the probability of the second user selection of the second application of the collection of applications based on user behavior patterns of another user.

In some implementations the operations include receiving a user selection of one of the one or more user selectable links, and executing the application access mechanism associated with the selected user selectable link. The executed application access mechanism associated with the selected user selectable link may launch the corresponding recommended application and sets the recommended application to an application state specified by the application access mechanism.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example environment including a user device in communication with a recommendation system.

FIG. 2 is a functional block diagram of an example system having a recommendation system that interacts with the user device and data sources.

FIG. 3A is a schematic view of an example probability table showing probabilities of applications being used after another application.

FIG. 3B is a schematic view of an example probability table showing probabilities of applications being used based on learned user states.

FIGS. 4A-4D are schematic views of example user devices displaying a recommendation bar.

FIG. 5 is a schematic view of an example user device.

FIG. 6 is an example arrangement of operations for a method of recommending applications for display in a recommendation bar of a user display.

FIG. 7 is a schematic view of an example computing device executing any systems or methods described herein.

Like reference symbols in the various drawings indicate like elements.

### DETAILED DESCRIPTION

The present disclosure provides a system and method for recommending one or more applications to a user based on usage of the applications by the user and/or other users. A recommendation system may select the one or more recommended applications from a collection of applications associated with the user. For example, the collection of applications may be installed on a user device associated with the user. The recommendation system may be part of one of the applications installed on the user device or part of a remote system in communication with the user device. The recommendation system receives an indication of a first user selection, such as a touch on a screen of the user device, of a first application of the collection of applications and identifies one or more applications of the collection of applications as one or more recommended applications satisfying criteria for a second user selection subsequent and sequential to the first user selection on the screen. The recommendation system can cause the display of the one or more recommended applications to the user, for example, in a recommendation bar on the screen of the user device.

In some examples, the recommendation system identifies a usage pattern of the user interacting with the collection of applications and determines the recommended applications based on the identified usage pattern. If the user has a history of using one particular application after another application, the user's experience may be enriched by receiving a recommendation in the recommendation bar for that particular application and/or other similar applications. The user device may display on the screen a user selectable link for each of the recommended applications, for example, in a screen area identified as the recommendation bar. The user selectable link is associated with an application access mechanism that references the corresponding recommended application and indicates a performable operation of the corresponding recommended application.

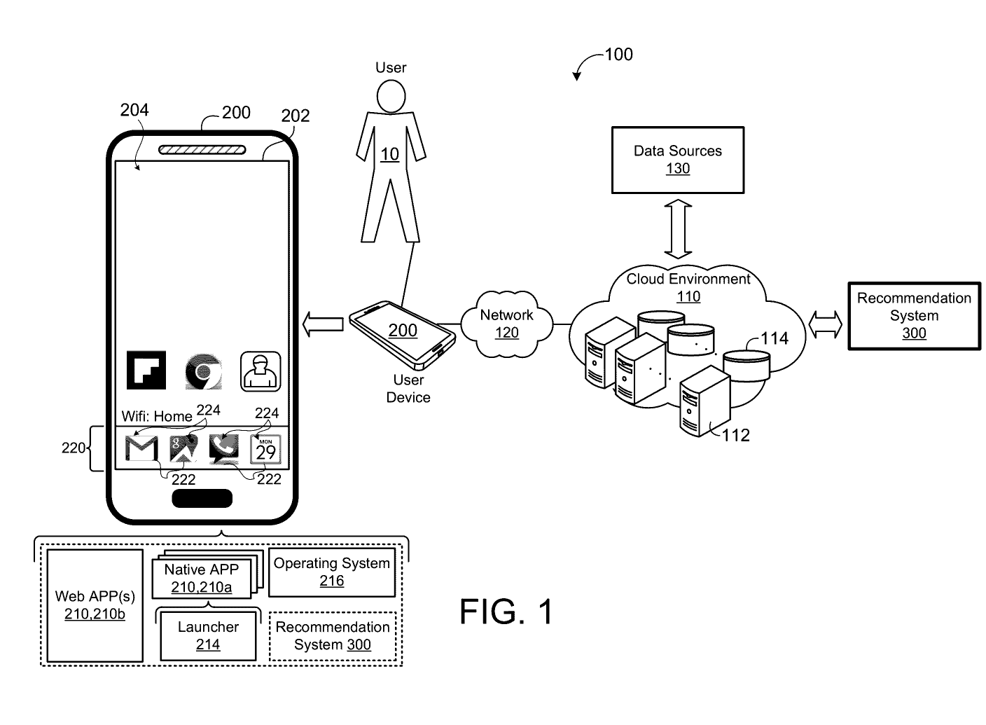

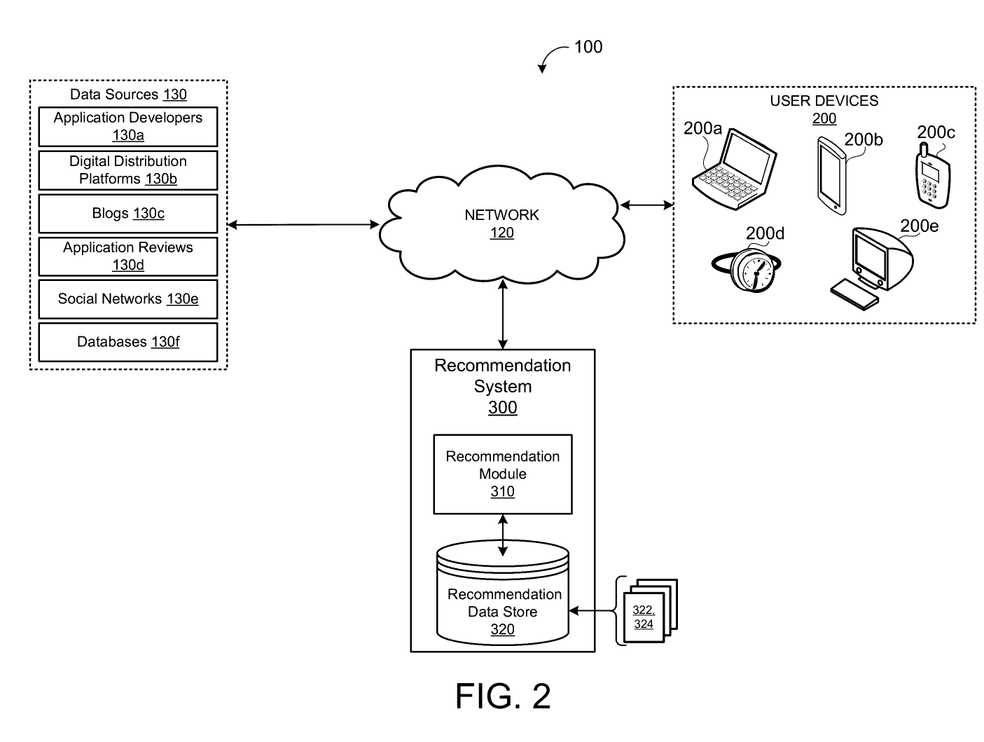

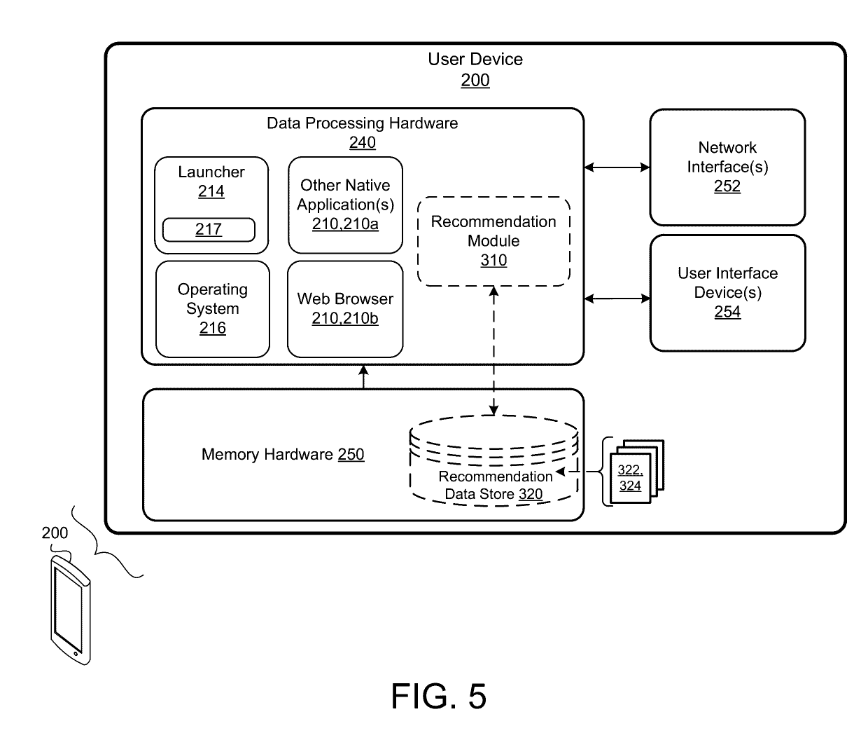

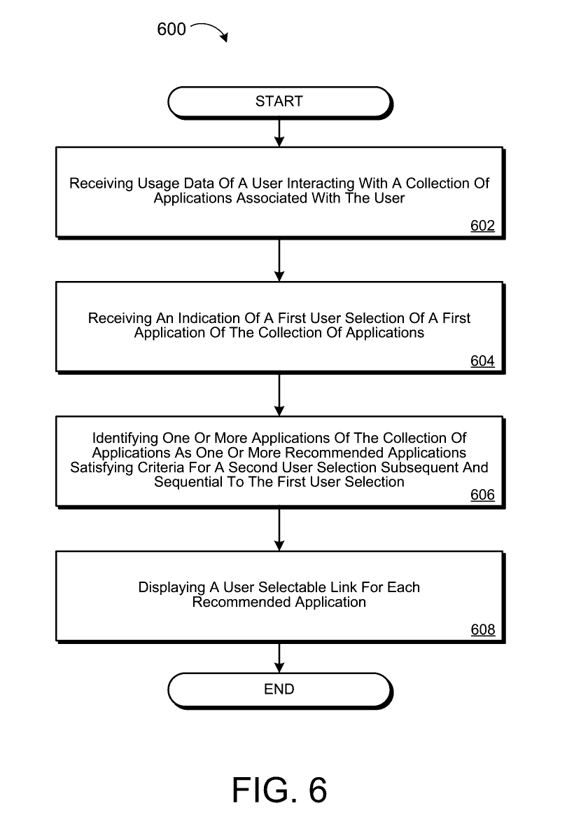

Referring to FIGS. 1 and 2, in some implementations, a system 100 includes a user device 200 associated with a user 10 in communication with a remote system 110 via a network 120. The remote system 110 may be a distributed system (e.g., cloud environment) having scalable/elastic computing resources 112 and/or storage resources 114. The user device 200 and/or the remote system 110 may implement a recommendation system 300 that optionally receives data from one or more data sources 130 or one or more other user devices 200. In some implementations, the recommendation system 300 communicates with the one or more user devices 200 and the data sources(s) 130 via the network 120. The network 120 may include various types of networks 120, such as a local area network (LAN), wide area network (WAN), and/or the Internet. As shown, in some implementations, the recommendation system 300 is separate from the user device 200; while in other implementations, the recommendation system 300 executes on the user device 200, as will be discussed with reference to FIGS. 5 and 6.

The data sources 130 may include a variety of different data providers. The data sources 130 may include data from application developers 130a, such as application developers' websites and data feeds provided by developers. The data sources 130 may include operators of digital distribution platforms 130b configured to distribute native applications 210a to user devices 200. Example digital distribution platforms 130b include, but are not limited to, the GOOGLE PLAY® digital distribution platform by Google, Inc., the APP STORE® digital distribution platform by Apple, Inc., and WINDOWS PHONE® Store developed by Microsoft Corporation.

The data sources 130 may also include other websites, such as websites that include web logs 130c (i.e., blogs), application review websites 130d, or other websites including data related to applications 210. Additionally, the data sources 130 may include social networking sites 130e, such as “FACEBOOK®” by Facebook, Inc. (e.g., Facebook posts) and “TWITTER®” by Twitter Inc. (e.g., text from tweets). Data sources 130 may also include online databases 130f that include, but are not limited to, data related to movies, television programs, music, and restaurants. Data sources 130 may also include additional types of data sources in addition to the data sources described above. Different data sources 130 may have their own content and update rate.

A software application 210 may refer to computer software that, when executed by a computing device, causes the computing device to perform a task. In some examples, a software application 210 may be referred to as an “application”, an “app”, or a “program”. Example software applications 210 include, but are not limited to, word processing applications, spreadsheet applications, messaging applications, media streaming applications, social networking applications, and games.

The user device 200 may be any computing device capable of displaying on a display 202 one or more icons/shortcuts 232 (associated with user selectable links 234) associated with one or more applications 210 stored on the user device 200. In addition, the user device 200 is capable of executing the one or more installed applications 210. User devices 200 include, but are not limited to, mobile computing devices, such as laptops 200a, tablets 200b, smart phones 200c, and wearable computing devices 200d (e.g., headsets and/or watches). User devices 200 may also include other computing devices having other form factors, such as computing devices included in desktop computers 200e, vehicles, gaming devices, televisions, or other appliances (e.g., networked home automation devices and home appliances).

The user devices 200 may use a variety of different operating systems 216. In examples where a user device 200 is a mobile device, the user device 200 may run an operating system including, but not limited to, ANDROID) developed by Google Inc., IOS® developed by Apple Inc., or WINDOWS PHONE® developed by Microsoft Corporation. Accordingly, the operating system 216 running on the user device 200 may include, but is not limited to, one of ANDROID®, IOS®, or WINDOWS PHONE®. In an example where a user device 200 is a laptop or desktop computing device, the user device 200 may run an operating system including, but not limited to, MICROSOFT WINDOWS® by Microsoft Corporation, MAC OS® by Apple, Inc., or Linux. User devices 200 may also access the recommendation system 300 while running operating systems 216 other than those operating systems 216 described above, whether presently available or developed in the future.

Applications 210 may be executed on a variety of different user devices 200. In some examples, a native application 210a may be installed on a user device 200 prior to a user 10 purchasing the user device 200. In other examples, the user 10 may download and install native applications 210a on the user device 200.

The functionality of an application 210 may be accessed on the computing device 200 on which the application 210 is installed. Additionally or alternatively, the functionality of an application 210 may be accessed via a remote computing device 112. In some examples, all of an application's functionality is included on the computing device 200 on which the application 210 is installed. These applications 210 may function without communication with other computing devices 200 (e.g., via the Internet). In other examples, an application 210 installed on a computing device 200 may access information from other remote computing devices 112 during operation. For example, a weather application installed on a computing device 200 may access the latest weather information via the Internet and display the accessed weather information to the user 10 through the installed weather application. In still other examples, a web-based application 210b (also referred to herein as a web application) may be partially executed by the user's computing device 200 and partially executed by a remote computing device 112. For example, a web application 210b may be an application 210 that is executed, at least in part, by a web server and accessed by a web browser (e.g., a native application 210a) of the user's computing device 200. Example web applications 210b may include, but are not limited to, web-based email, online auctions, and online retail sites.

A user 10 may install a multitude of applications 210 on his/her user device 200 and then find it difficult to locate a specific application 210 at any given time. Therefore, it is desirable monitor and learn a usage of the applications 210 associated with the user 10 (e.g. applications 210 installed on the user device 200) and dynamically suggests one or more applications 210 to the user 10 based on one or more factors or criteria, such as but not limited to, usage data of consecutively and sequentially used applications 210 within a threshold period of time, a time of day, a location of the user device 200, or any other usage data. Therefore, recommending applications 210 based on the criteria specified may reduce the number of steps that the user 10 may make to open an application 210. The recommendation system 300 may suggest recommended applications 222 for display in a recommendation bar 210 of a graphical user interface (GUI) 204.

In general, the user device 200 may communicate with the recommendation system 300 using any software application 210, such as a recommendation launcher 214, which monitors the user's usage data 322 and provides recommended applications 222 to the user 10. Usage data may include, but is not limited to, a user's interaction with an application 210, a time/date that a user 10 opens an application 210, duration of using an application 210, a time/date of closing the application 210, frequency of using the application 210, or any other relevant data indicative of the user's interaction with the application 210 via the GUI 204. The recommendation launcher 214 may be an application user interface program that is installed on the user device 200 that replaces a native home screen with a more customizable interface allowing the GUI 204 to display the recommendation bar 220 dedicated to displaying recommended applications 222. The recommendation launcher 214 allows the user 10 or the user device 200 (e.g., the recommendation system 300), to personalize a home screen of the GUI 204 of the user device 200. In some implementations, the recommendation launcher 214 also manages a home screen, wallpaper(s), a launch bar, an application installation, shortcuts, and widgets.

In some examples, the user device 200 executes the recommendation launcher 214 that is dedicated to interfacing with the recommendation system 300 (executing on the user device 200 or remotely). The user device 200 may communicate with the recommendation system 300 using a more general application 210, such as a web-browser application 210b accessed using a web browser native application 210a. Although the user device 200 may communicate with the recommendation system 300 using the recommendation launcher 214 and/or a web-browser application 210b, the user device 200 may be described hereinafter as using the recommendation launcher 214 to communicate with the recommendation system 300. In some implementations, the functionality attributed to the recommendation launcher 214 is included as a recommendation component of a larger application 210 that has additional functionality. For example, the functionality attributed to the recommendation launcher 214 may be included as part of a native application 210a or a web application 210b as a feature that provides monitoring capabilities for recommending applications.

In some implementations, as shown in FIG. 2, the recommendation system 300 includes a recommendation module 310 in communication with a recommendation data store 320. The recommendation system 300 receives usage data 322 associated with the user 10. The recommendation module 310 analyzes the received data and stores the analyzed data in the recommendation data store 320. The usage data 322 includes data relating to the interactions of the user 10 with one or more applications 210 installed on the user device 200 or otherwise associated with the user 10. In some examples, the recommendation system 300 receives usage data 322 of multiple users 10.

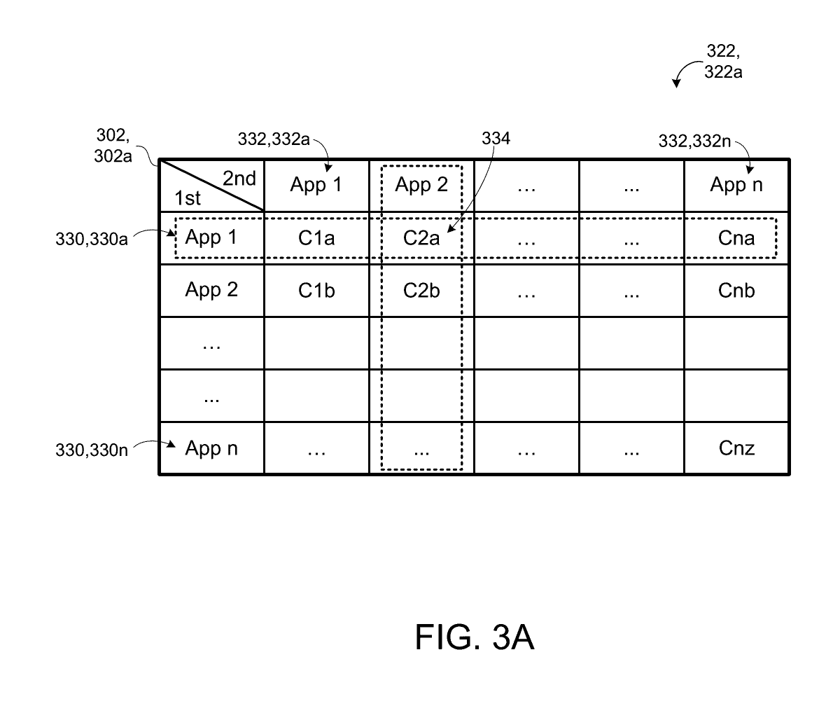

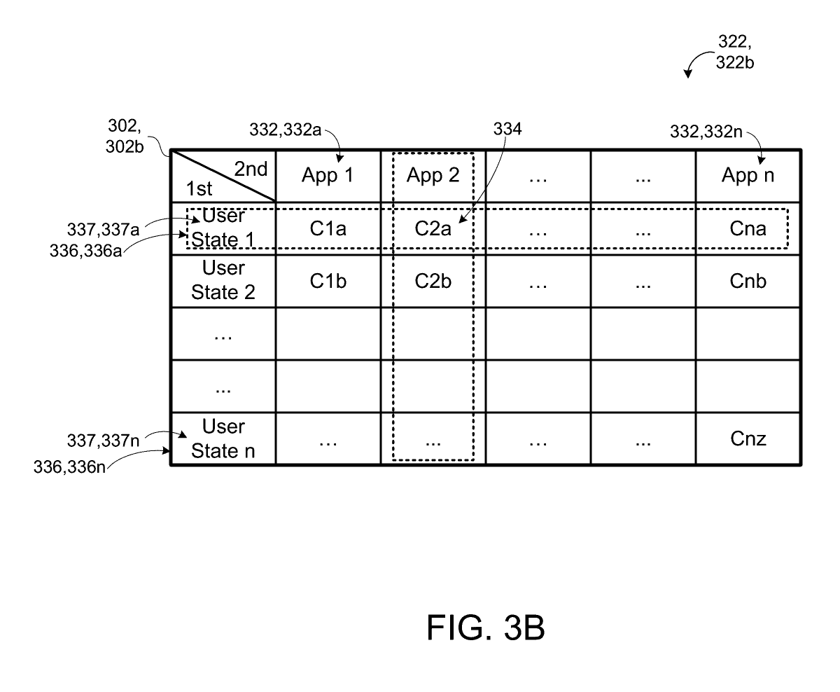

Referring to FIGS. 2, 3A, and 3B, in some implementations, the recommendation module 310 receives usage data 322, 322a, 322b from one or more user devices 200, processes the received usage data 322, and stores the processed usage data 322 on the recommendation data store 320. Based on the received usage data 322 (e.g., stored in the recommendation data store 320), the recommendation module 310 determines the most likely or the most probable application(s) 210 that the user 10 may use within a threshold period of time (T) provided that the user 10 used a specific application 210 previously (as shown in FIG. 3A) or based on one or more user states (as shown in FIG. 3B). As shown in FIG. 3A, the recommendation module 310 organizes the usage data 322a in such a way as to readily determine a probability (C1a-Cnz) that the user 10 uses an application 210 (columns 332) after using another application 210 (rows 330). Thus, the recommendation module 310 determines the probability (C1a-Cnz) of a first application 210, 330a-n (App 1-App n) being used first, followed by a second application 210, 332a-n (App 1-App n) being used second within a threshold period of time (T) or sequentially after the first application 330a-n. For example, a user 10 may often use the OPENTABLE® application (first application 330a-n) to make a reservation at a restaurant; the user 10 may then use the UBER® application (second application 332a-n) to submit a trip request to and from the restaurant. The use of the OPENTABLE® application and the UBER® application may occur within the threshold period of time (T). The recommendation module 310 may receive the usage data 322a of the user's use of the OPENTABLE® application followed by the UBER® application and determine a pattern of the user 10 that every time the user 10 makes a reservation at a restaurant with the OPENTABLE® application, the user 10 opens the UBER® application to obtain transportation to and from the restaurant, where the user 10 uses the applications 210 sequentially and within the threshold period of time (T). Therefore, the recommendation module 310 learns or determines a probability of the user's use of the UBER® application when the OPENTABLE® application 210 is open. The more the user 10 opens the UBER® application after the OPENTABLE® application, the probability increases. Therefore, when the user 10 opens the OPENTABLE® application, the recommendation system 300 may recommend the UBER® application for display in the recommendation bar 220.

As shown in FIG. 3B, the recommendation module 310 organizes the usage data 322b in such a way as to readily determine a probability (C1a-Cnz) that the user 10 uses an application 210 (columns 332) during a user state 337 (rows 336). A user state 337 may be a location, a time, proximity of a location, an activity, etc. For example, a user state 337 may be, but is not limited to, morning, evening, lunch time, at home, driving, weekend, weekday, running, or walking. Thus, the recommendation module 310 determines the probability (C1a-Cnz) of an application 210, 330a-n (App 1-App n) being used during or following a user state 337 (row 336a-336n) within a threshold period of time (T) within the beginning of the user state 337 or sequentially after the user state 337. For example, a user 10 may drive home from work daily around 6 pm, in such a case the recommendation system 300 learns that the user state 337 is ‘driving,’ or ‘driving home,’ or ‘weekday driving.’ The recommendation system 300 may also learn that the user 10 uses the GOOGLE MAP application when one of those states 337 is occurring. Therefore, the recommendation system 300 monitors the user's usage data 332b to determine the applications 210 to recommend as recommendation applications 222 when a user 10 is in a learned user state 337.

The recommendation module 310 may organize the usage data 322 in the form of a table or matrix 302 that shows the number of times an application 210 is used following another application 210 (FIG. 3A) or during or after a user state 377 (FIG. 3B). The table or matrix 302a shown in FIG. 3A includes rows 330 and columns 332. The rows 330 and columns 332 represent the applications 210 stored on the user device 200. Each row 330 and column 332 defines a cell 334. Each cell 334 represents a number of times a user 10 opens a second application 210, 332 within a threshold period of time (T) of opening a first application 210, 330. As shown, the rows 330 represent the application(s) 210 on the user device 200 that the user 10 opens first, and the columns 332 represent the application(s) 210 on the user device 200 that the user 10 opens second. In some examples, for each application 210 representing a row 330, the recommendation module 310 determines a number of applications 210, represented in the columns 332 that are highly likely to be used after the user 10 uses a first application 210. For example, the recommendation module 310 determines the probability of each application 210, 332a-n on the user device 200 being used after a first application 210, 330a-n. The recommendation module 310 may select a threshold number of applications 210 having the highest probability of being opened after a first application 210, 330a-n and provide those applications 210 to the user 10 by displaying them as recommended applications 222 in the recommendation bar 220.

The table or matrix 302b shown in FIG. 3B includes rows 336 and columns 332. The rows 336 represent user states 337 and the columns 332 represent the applications 210 stored on the user device 200. Each row 336 and column 332 defines a cell 334. Each cell 334 represents a number of times a user 10 opens a second application 210, 332 during or within a threshold period of time (T) of the user state 337. As shown, the rows 337 represent a user state 337, and the columns 332 represent the application(s) 210 on the user device 200 that the user 10 opens during or after the user state 337. In some examples, for each user state 337 representing a row 336, the recommendation module 310 determines a number of applications 210, represented in the columns 332 that are highly likely to be used during or after the user state 337. For example, the recommendation module 310 determines the probability of each application 210, 332a-n on the user device 200 being used during or after a user state 337, 337a-n. The recommendation module 310 may select a threshold number of applications 210 having the highest probability of being opened during or after a user state 337, 337a-n and provide those applications 210 to the user 10 by displaying them as recommended applications 222 in the recommendation bar 220.

In the examples shown, the applications 210 in the table 302, 302a, 302b are associated with one user 10. However, the recommendation system 300 may generate one or more other tables 302, 302a, 302b for determining the probability (C1a-Cnz) of a second application 210, 332 a-n being used after a first application 210, 330a-n (FIG. 3A) or during or after a user state 377 (FIG. 3B) based on usage data 322, 322a, 322b of multiple users 10, where the multiple users 10 include the user of the device 200. The matrix or table 302, 302a, 302b may be represented as tuples using row-major order or column-major order, which describes the method of arranging a multidimensional array in linear storage, such as memory. A tuple is a finite ordered list of elements. For example, an n-tuple is defined inductively using the construction of an ordered pair.

In some implementations, the recommendation system 300 considers a user's contextual information 324, such as but not limited to, the time of day (TOD), day of week (DOW), location, home/roaming (Boolean), driving (fast moving)/stationary (slow moving) (Boolean), device (i.e. iPhone, Android). The recommendation system 300 may monitor the user's use of the applications 210 installed on the user device 200 and determine a pattern of usage behavior of each application 210. For example, a user 10 may use a specific application (APP A) at location B daily around 11 am. Therefore, the recommendation system 300 may recommend that specific application (APP A) as a recommended application 222 to be shown in the recommendation bar 220 every day, at or before 11 am. In some examples, the user 10 starts the Google Map application when the user device 200 is either connected to the vehicle's BLUETOOTH®, when the user device 200 is moving in a vehicle, and/or every day at a specific time (e.g., 8 am and 5 pm). In such an instance, the recommendation device 300 recommends the GOOGLE MAP® application 222 to be included in the recommendation bar 220 when one or more of the criteria listed are satisfied. The recommendation system 300 may use contextual information 324 of one or more users 10 to determine the recommended applications 222 for a specific user 10. For example, the recommendation system 300 may use the contextual information 324 of a user 10 within a group of users 10 having one or more similar applications 204 downloaded on their respective user devices 200.

In some implementations, the recommendation system 300 considers a user's location or connectivity to determine the recommended application(s) 222. A user's location may be determined based on geo-location data associated with the user device 200 and/or a connectivity of the user device 200 with one or more other devices (e.g., Wi-Fi™ connection, Bluetooth® connection, pairing with one or more other devices, or any other connection between the user device 200 and any other device. For example, a user 10 may have a daily morning routine that includes leaving his/her home where he/she is connected to a Wi-Fi network, e.g., Home Network, and book a cab using the UBER® application. The recommendation system 300 determines that every day the user 10 leaves his house (i.e., the Home Network) the user 10 opens the UBER® application to book a cab. Therefore, the recommendation system 300 recommends the UBER® application as a recommended application 222 when the user 10 leaves the Home Network. As another example, the recommendation system 300 may determine that the user 10 uses one or more applications 210 when the user 10 is at a certain location or connected to a certain network. In this case, the recommendation system 300 includes the one or more applications 210 as recommended applications 222 in the recommendation bar 220, when the user device 200 is connected to the specific network or at the specific location. For example, when the user device 200 is connected to his/her work network, the recommendation system 300, and based on monitoring the user's behavior, might recommend a work email application 222 that the user 10 opens at a certain time daily while connected to the work network or at work. However, although the user 10 uses the work email application 210 daily when at work, the user 10 may not use the work email application when he/she is not at work. Therefore, the recommendation system 300 may not recommend the work email application 210 if the recommendation system 300 determines that the user 10 is not at work (based on the location or connectivity information). In some example, and although the user 10 may not be at work, the recommendation system 300 may still recommend the work email application based on other factors, such as co-occurrences and/or contextual information 324.

In some implementations, the recommendation system 300 clusters users 10 based on the installed applications 210 associated with each user device 200 and recommends a recommended application 222 to a user 10 based on one or more cluster that the user 10 is associated with. In some examples, the user 10 may be associated with one or more user clusters. For example, if a user 10 installs the UBER® application 210 on his user device 200 or already has the UBER® application installed 210, then the recommendation system 300 may cluster the user 10 with other users 10 having the UBER® application or similar applications 210 installed on their user devices 200. The recommendation system 300 may cluster the user 10 with a first cluster of users 10, e.g., GROUP A, that includes users 10 who rarely use the UBER®V application 210, for example when traveling. In addition, the recommendation system 300 may cluster the user 10 with a second cluster of users 10, e.g., GROUP B that includes users 10 who have several restaurant or restaurant reservation applications 210 and tend to use the UBER® application 210 after they make a reservation at a restaurant using one of the restaurant or restaurant reservation applications 210, or regularly use the UBER® application (e.g., two or more times a week). In some examples, the recommendation system 300 clusters the first and second groups together, which allows the recommendation system 300 to learn that users 10 of the first group (GROUP A) do not use the UBER® application 210 every day and therefore; while the recommendation system 300 learns that users 10 of the second group (GROUP B) use the UBER® application 210 regularly. Therefore, the recommendation system 300 recommends the UBER® application 210 as a recommendation application 222 in the recommendation bar 220 to the users 10 of the second group (GROUP B) more often than recommending the UBER® application to the users 10 of the first group (GROUP A). The probability of the recommendation system 300 recommending the UBER® application 210 as a recommendation application 222 is different based on the user 10, and the cluster of users 10 that the user is associated with. Referring back to the example, the probability P (R_APP) of the recommendation system 300 recommending the UBER® application 210 as recommendation application 222 to the first group (GROUP A) is less than the probability P (R_APP) of recommending the UBER® application to 210 as a recommendation application to the second group (GROUP B).

The recommendation system 300 may recommend a recommended application 222 to the user 10 based on application co-occurrences and/or contextual information 324 and/or location/connectivity. The recommendation system 300 retrieves/receives usage data 322 and contextual information 324 and determines a pattern of behavior (e.g., co-occurrences and/or contextual information and/or location/connectivity). A recommendation of recommended applications 222 based on co-occurrences of applications 210 may be based on monitoring an application 210 being used within a threshold time (T) after a specific application 210. Recommendations based on contextual information 324 may be based on contextual change. For example, if the user 10 has a habit or pattern of using the UBER® application to go home followed by the GRUBHUB® application, the recommendation system 300 may suggest the GRUBHUB® application based on an application co-occurrence of the user 10 using the GRUBHUB® application to order food right after using the UBER® application to be driven home from work. Thus, the recommendation system 300 shows the GRUBHUB® application in the recommendation bar 220 as a recommended application 222 when the user 10 selects the UBER® application. The recommendation system 300 may show the GRUBHUB® application (i.e., the co-occurrence recommendation) for a threshold period of time and then replaces it with contextual recommended applications 222 based on contextual information 324. Similarly, if the user 10 stops using the GRUBHUB® recommended application 222 from the recommendation bar 220 for a threshold period of time, the recommendation system 300 may stop recommending the GRUBHUB® application a recommended application 222.

In some implementations, the recommendation system 300 uses usage data 322 and/or contextual data 324 and/or location/connectivity of multiple users 10 to make recommendations of applications 210. When the user 10 first installs an application 210 on his/her device 200, the recommendation system 300 may not have enough usage data 322 to determine what applications 210 to recommend for use after the recently installed application 210. In such a situation, the recommendation system 300 may use usage data 322 of other users 10 who have used the recently installed application 210. In some examples, the recommendation system 300 clusters users 10 having a number of similar attributes (e.g., applications 210) as the user 10, and determines the recommended applications 222 based on the users 10 having the similar attributes. When the recommendation system 300 collects enough usage data 322 of the user 10, the recommendation system 300 may only consider the usage data 320 of the user 10, and not the group of users 10 having similar attributes. In addition, the group usage data may be used to recommend applications 210 to the user 10 that he/she does not have installed on the user device 200. In some examples, the user device 200 displays a small icon indicating that the application 210 is not installed on the user device 200. In some examples, if a user 10 is at an event (e.g., a concert), the recommendation system 300 may monitor the usage of other users 10 at the same event, i.e., within a threshold distance from the user's geo-location or using the same network, and determine recommended applications 222 to the user 10 based on the other users 10. For example, if a user 10 is at a concert and other users 10 within the vicinity of the user 10 are downloading an application (e.g., associated with the concert), the recommendation system 300 may update the recommendation bar 220 of the user 10 with a recommended application 222 being the application that the other users 10 are downloading. In this case, the recommended application 222 allows the user 10 to download the recommended application 222.

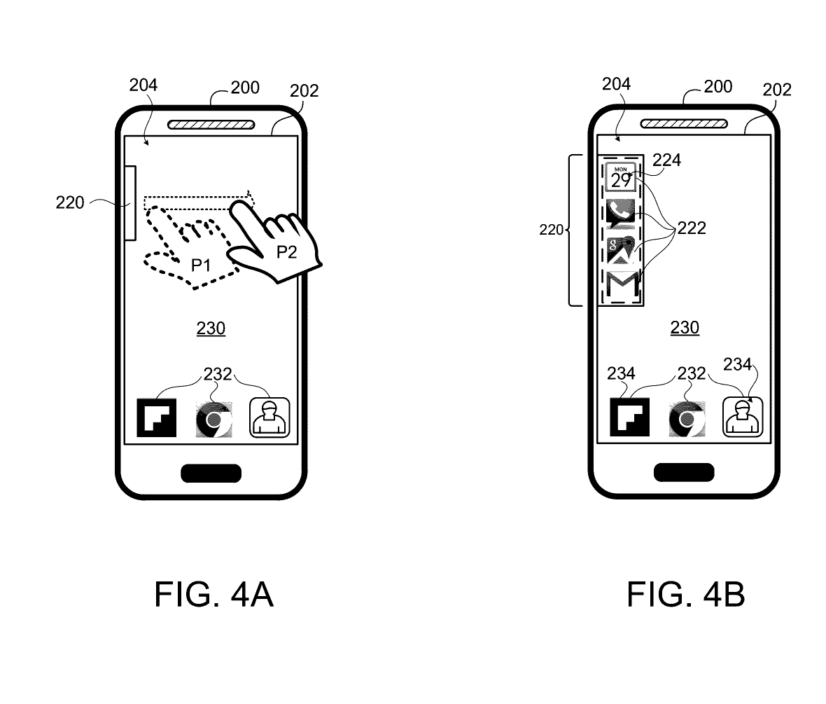

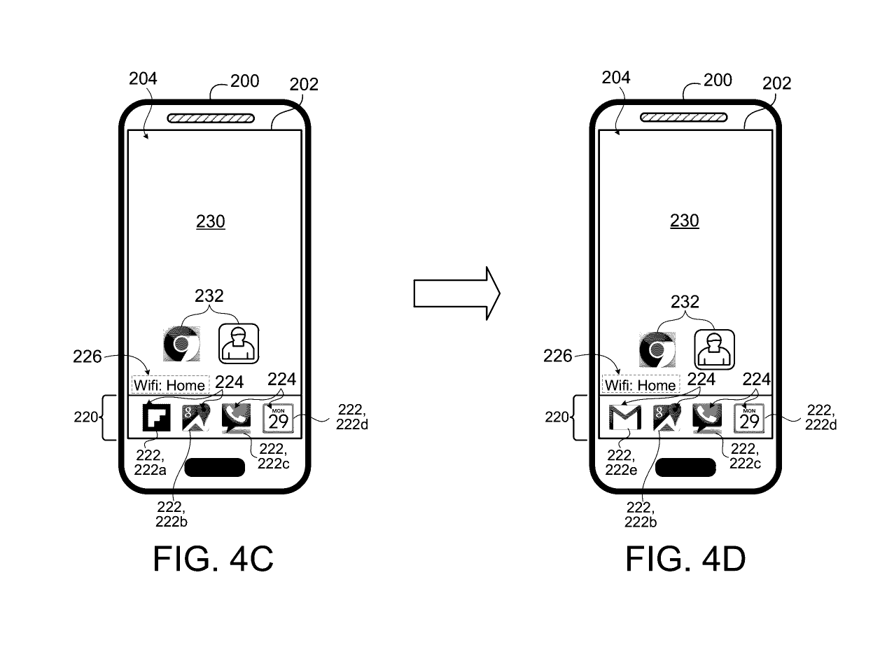

FIGS. 4A-4D show example recommendation bars 220 displayed by example user devices 200. As shown in FIG. 4A, in some implementations, the display 202 of the user device 200 includes a home screen 230. The home screen 230 includes links 224, 234 displayed as icons 222, 232 associated with applications 210 installed on the user device 200. Each link 224, 234 may be selectable by the user 10 and has an access mechanism that has a reference to the corresponding application 210 and indicates a performable operation for the corresponding recommended application 222.

Access mechanisms may include at least one of a native application access mechanism (hereinafter “application access mechanism”), a web access mechanism, and an application download mechanism. The user device 200 may use the access mechanisms to access functionality of applications 210. For example, the user 10 may select a user selectable link 224, 234 on the home screen 230 or other screens including an access mechanism in order to access functionality of an application 210 indicated in the user selectable link 224, 234.

An application access mechanism may be a string that includes a reference to a native application and indicates one or more operations for the user device 200 to perform. If a user 10 selects a user selectable link 224, 234 including an application access mechanism, the user device 200 may launch the native application 210 referenced in the application access mechanism and perform the one or more operations indicated in the application access mechanism.

An application access mechanism includes data that the user device 200 can use to access functionality provided by a native application. For example, an application access mechanism can include data that causes the user device 200 to launch a native application and perform a function associated with the native application. Performance of a function according to the access mechanism may set the native application into a specified state. Accordingly, the process of launching a native application and performing a function according to an application access mechanism may be referred to herein as launching the native application and setting the native application into a state that is specified by the application access mechanism. In some examples, an application access mechanism for a restaurant reservation application can include data that causes the user device 200 to launch the restaurant reservation application and assist in making a reservation at a restaurant. In such examples, the restaurant reservation application may be set in a state that displays reservation information to the user 10, such as a reservation time, a description of the restaurant, and user reviews. In additional examples, an application access mechanism for an internet media player application can include data that causes the user device 200 to launch the internet media player application and stream media from the Internet. In such examples, the internet media player application may be set in a state that displays information regarding the media (e.g., music) being streamed, such as a song name, an artist, or an album name.

Application access mechanisms may have various different formats and content. The format and content of an application access mechanism may depend on the native application 210 with which the application access mechanism is associated and the operations that are to be performed by the native application 210 in response to selection of the application access mechanism. For example, an application access mechanism for an internet music player application may differ from an application access mechanism for a shopping application. An application access mechanism for an internet music player application may include references to musical artists, songs, and albums, for example. The application access mechanism for an internet music player application may also reference operations, such as randomizing a list of songs and playing a song or album. An application access mechanism for a shopping application may include references to different products that are for sale. The application access mechanism for the shopping application may also include references to one or more operations, such as adding products to a shopping cart and proceeding to a checkout.

With continued reference to FIG. 4A, the recommendation bar 220 may be hidden and the user 10 has to swipe his/her finger from a first position P1 to a second position P2 to view the recommended applications 222 (i.e., the respective icons), as shown in FIG. 4B. In additional examples shown in FIGS. 4C and 4D, the recommendation bar 220 is displayed on the bottom portion of the screen 202. However, the recommendation bar 220 may be displayed anywhere else on the screen 202. As shown in FIG. 4C, the recommended applications 222a-222d are displayed. Due to a user selection of an application 210 that may be a recommended application 222 or another application icon 232 of an application 210 on the home screen 230, the GUI 204 is updated as shown in FIG. 4D. FIG. 4D shows the updated recommendation bar 220 having a recommended application 222e replacing the recommended application of FIG. 4C. In some implementations, the recommendation system 300 may also consider a location/connectivity of the user device 200. As shown in FIGS. 4C and 4D, in some examples, the user device 200 displays a connectivity status 226. In this case, the user device is connected to a Home Wi-Fi network.

FIG. 5 illustrates an example user device 200 including data processing hardware 240 in communication with memory hardware 250, a network interface device 252, and a user interface device 254 (e.g. screen). The user device 200 may include other components as well. The data processing hardware 240 is configured to execute instructions stored on the memory hardware that when executed on the data processing hardware cause the data processing hardware to perform operations. In some examples, the data processing hardware 240 executes one or more of a native application 210a, a web browser 210b, and an operating system 216, all of which may be embodied as computer readable instructions. The operating system 216 may act as an interface between the data processing hardware 240 and the applications 210.

In some implementations, the data processing hardware 240 executes a recommendation launcher 214 configured with a launcher module 217. The launcher module 217 is a set of computer readable instructions embedded in a native application 210a, i.e., the recommendation launcher 214. In the example shown, the data processing hardware 240 executes the recommendation module 310 and the storage device 250 includes the recommendation data store 320. In other examples, the recommendation data store 320 is located remotely from the user device 200.

The memory hardware 250 may be physical devices used to store programs (e.g., sequences of instructions) or data (e.g., program state information) on a temporary or permanent basis as non-transitory memory for use by a computing device. For example, the memory hardware 250 may store the computer readable instructions that make up the native applications 210a, the web browser 210b, the operating system 216, the launcher 214, and/or the recommendation module 310. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM). The network interface device 252 includes one or more devices configured to communicate with the network 120.

The network interface 252 can include one or more transceivers for performing wired or wireless communication. Examples of the network interface 252 include, but are not limited to, a transceiver configured to perform communications using the IEEE 802.11 wireless standard, an Ethernet port, a wireless transmitter, and a universal serial bus (USB) port. The user interface 254 includes one or more devices that receive input from and/or provide output to a user 10. The user interface 254 can include, but is not limited to, a touchscreen, a display, a QWERTY keyboard, a numeric keypad, a touchpad, a microphone, and/or speakers.

FIG. 6 provides an example arrangement of operations for a method 600 of recommending applications (e.g., recommended applications 222) displayed in a recommendation bar 220 of a user display 202. The method 600 is described with respect to the user device 200 and the recommendation system 300 as illustrated in FIGS. 1-5.

At block 602, the method 600 includes receiving, at data processing hardware 240 (of the user device 200 or the recommendation system 300), usage data 322 of the user 10 interacting with a collection of applications 210 associated with the user 10. At block 604, the method 600 includes receiving an indication of a first user selection of a first application 210, 330 of the collection of applications 210 on a screen 202 in communication with the data processing hardware 240. At block 606, the method 600 includes identifying one or more applications 210, 332 of the collection of applications 210 as one or more recommended applications 222 satisfying criteria for a second user selection subsequent and sequential to the first user selection on the screen 202. At block 608, the method 600 includes displaying on the screen 202 a user selectable link 224 (represented by a recommended application icon 222) for each identified recommended application 222. Each user selectable link 224 is associated with an application access mechanism having a reference to the corresponding recommended application 222 and indicating a performable operation for the corresponding recommended application 222. In some implementations, the criteria for the second user selection includes having a threshold probability (C_{TH}) of the second user selection within a threshold period of time (T) after the first user selection of the first application.

In some examples, the method 600 includes determining a probability (Ca1-Cnz) of the second user selection of a second application 210, 332 of the collection of applications 210 within the threshold period of time (T) after receiving the indication of the first user selection of the first application 210, 330. The method 600 may also include identifying the second application 210, 332 as the recommended application 222 when the probability of the second user selection of the second application 210, 332 satisfies the threshold probability (C_{TH}).

The indication of the first user selection may indicate at least one of a selection of a representation associated with the first application on the screen 202 or execution of the first application 210, 330. In some examples, the criteria for the second user selection includes at least one of a time of day, a day of week, a location, a user device service status, a user device movement status, a device platform, or contextual information 324. Additionally, in some examples, the method 600 also includes determining user behavior patterns with respect to the collection of applications 210 based on the criteria, and determining a probability (Ca1-Cnz) of the second user selection of a second application 210, 332 of the collection of applications 210 based on the user behavior patterns after receiving the indication of the first user selection of the first application 210, 330. The method 600 may also include identifying the second application 210, 332 as a recommended application 222 when the probability (Ca1-Cnz) of the second user selection of the second application 210, 332 satisfies a probability criterion. The user behavior patterns may include at least one of selecting an application 210 of the collection of applications 210 or performing one or more operations on an application 210 of the collection of applications 210. In some examples, the method 600 also includes determining the probability (Ca1-Cnz) of the second user selection of the second application 210, 332 of the collection of applications 210 based on user behavior patterns of another user 10.

In some implementations, the method 600 also includes receiving a user selection of one of the one or more user selectable links 224, 234, and executing the application access mechanism associated with the selected user selectable link 224, 234. The executed application access mechanism associated with the selected user selectable link 224, 234 may launch the corresponding recommended application 222 and sets the recommended application 222 to an application state specified by the application access mechanism.

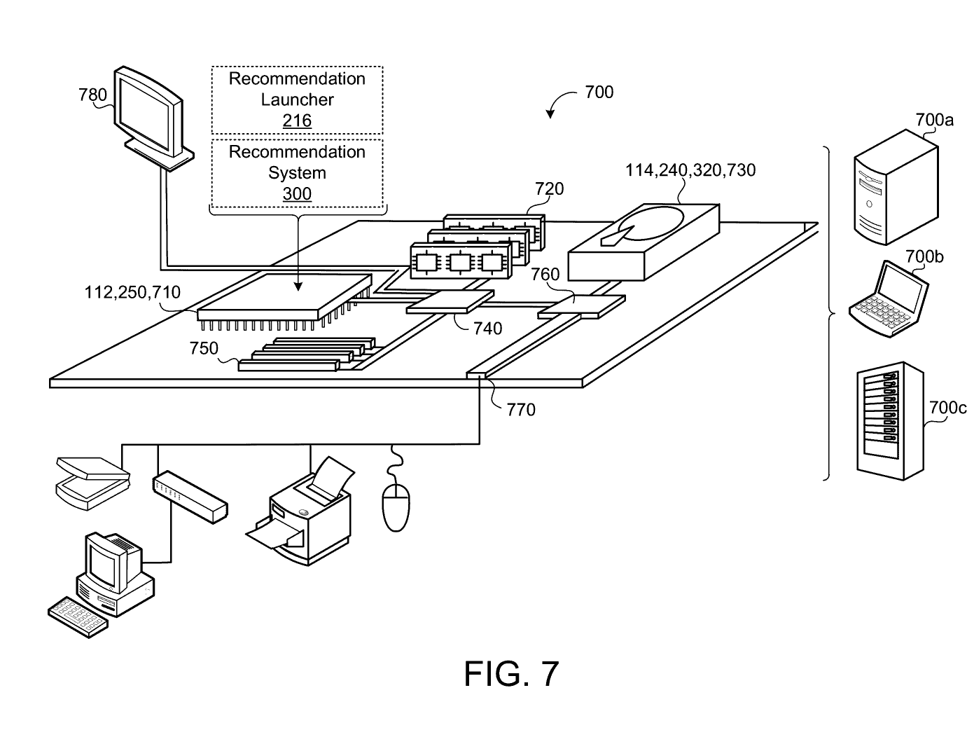

FIG. 7 is schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 112, 250, 710, memory 720, a storage device 114, 240, 320, 730, a high-speed interface/controller 740 connecting to the memory 720 and high-speed expansion ports 750, and a low speed interface/controller 760 connecting to low speed bus 770 and storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM).

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and low-speed expansion port 770. The low-speed expansion port 770, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at data processing hardware, usage data of a user interacting with a collection of applications associated with the user;
receiving, at the data processing hardware, an indication of a first user selection of a first application of the collection of applications on a screen in communication with the data processing hardware;
identifying, by the data processing hardware, one or more applications of the collection of applications as one or more recommended applications satisfying criteria for a second user selection subsequent and sequential to the first user selection on the screen; and
displaying on the screen, by the data processing hardware, a user selectable link for each recommended application, each user selectable link associated with an application access mechanism having a reference to the corresponding recommended application and indicating a performable operation for the corresponding recommended application.

2. The method of claim 1, wherein the criteria for the second user selection comprises having a threshold probability of the second user selection within a threshold period of time after the first user selection of the first application.

3. The method of claim 2, further comprising:
determining, by the data processing hardware, a probability of the second user selection of a second application of the collection of applications within the threshold period of time after receiving the indication of the first user selection of the first application; and
identifying, by the data processing hardware, the second application as a recommended application when the probability of the second user selection of the second application satisfies the threshold probability.

4. The method of claim 1, wherein the indication of the first user selection indicates at least one of a selection of a representation associated with the first application on the screen or execution of the first application.

5. The method of claim 1, wherein the criteria for the second user selection comprises at least one of a time of day, a day of week, a location, a user device service status, a user device movement status, a device platform, or contextual information.

6. The method of claim 5, further comprising:
determining, by the processing hardware, user behavior patterns with respect to the collection of applications based on the criteria;
determining, by the processing hardware, a probability of the second user selection of a second application of the collection of applications based on the user behavior patterns after receiving the indication of the first user selection of the first application; and
identifying, by the data processing hardware, the second application as a recommended application when the probability of the second user selection of the second application satisfies a probability criterion.

7. The method of claim 6, wherein the user behavior patterns comprise at least one of selecting an application of the collection of applications or performing one or more operations on an application of the collection of applications.

8. The method of claim 6, further comprising determining the probability of the second user selection of the second application of the collection of applications based on user behavior patterns of another user.

9. The method of claim 1, further comprising:
receiving, at the data processing hardware, a user selection of one of the one or more user selectable links; and
executing, at the data processing hardware, the application access mechanism associated with the selected user selectable link.

10. The method of claim 9, wherein the executed application access mechanism associated with the selected user selectable link launches the corresponding recommended application and sets the recommended application to an application state specified by the application access mechanism.

11. A system comprising:
data processing hardware; and
memory hardware in communication with the data processing hardware, the memory hardware storing instructions that when executed on the data processing hardware cause the data processing hardware to perform operations comprising:
receiving usage data of a user interacting with a collection of applications associated with the user;
receiving an indication of a first user selection of a first application of the collection of applications on a screen in communication with the data processing hardware;
identifying one or more applications of the collection of applications as one or more recommended applications satisfying criteria for a second user selection subsequent and sequential to the first user selection on the screen; and
displaying on the screen a user selectable link for each recommended application, each user selectable link associated with an application access mechanism having a reference to the corresponding recommended application and indicating a performable operation for the corresponding recommended application.

12. The system of claim 11, wherein the criteria for the second user selection comprises having a threshold probability of the second user selection within a threshold period of time after the first user selection of the first application.

13. The system of claim 12, wherein the operations further comprise:
determining a probability of the second user selection of a second application of the collection of applications within the threshold period of time after receiving the indication of the first user selection of the first application; and
identifying the second application as a recommended application when the probability of the second user selection of the second application satisfies the threshold probability.

14. The system of claim 11, wherein the indication of the first user selection indicates at least one of a selection of a representation associated with the first application on the screen or execution of the first application.

15. The system of claim 11, wherein the criteria for the second user selection comprises at least one of a time of day, a day of week, a location, a user device service status, a user device movement status, a device platform, or contextual information.

16. The system of claim 15, wherein the operations further comprise:
determining user behavior patterns with respect to the collection of applications based on the criteria;
determining a probability of the second user selection of a second application of the collection of applications based on the user behavior patterns after receiving the indication of the first user selection of the first application; and
identifying the second application as a recommended application when the probability of the second user selection of the second application satisfies a probability criterion.

17. The system of claim 16, wherein the user behavior patterns comprise at least one of selecting an application of the collection of applications or performing one or more operations on an application of the collection of applications.

18. The system of claim 16, wherein the operations further comprise determining the probability of the second user selection of the second application of the collection of applications based on user behavior patterns of another user.

19. The system of claim 11, wherein the operations further comprise:
receiving a user selection of one of the one or more user selectable links; and
executing the application access mechanism associated with the selected user selectable link.

20. The system of claim 19, wherein the executed application access mechanism associated with the selected user selectable link launches the corresponding recommended application and sets the recommended application to an application state specified by the application access mechanism.

21. A method comprising:
receiving, at data processing hardware, usage data associated with a group of users, the usage data describing interactions of the users with a collection of applications;
receiving, at the data processing hardware, an indication of a first user selection of a first application of the collection of applications;
identifying, by the data processing hardware, one or more applications of the collection of applications as one or more recommended applications satisfying criteria for a second user selection subsequent and sequential to the first user selection; and
displaying on a screen in communication with the data processing hardware a user selectable link for each recommended application, each user selectable link associated with an application access mechanism having a reference to the corresponding recommended application and indicating a performable operation for the corresponding recommended application.

22. The method of claim 21, wherein the criteria for the second user selection comprises having a threshold probability of the second user selection within a threshold period of time after the first user selection of the first application, the threshold probability associated with the usage data associated with the group of users.

23. The method of claim 22, further comprising:
determining, by the data processing hardware, a probability of the second user selection of a second application of the collection of applications within the threshold period of time after receiving the indication of the first user selection of the first application; and
identifying, by the data processing hardware, the second application as a recommended application when the probability of the second user selection of the second application satisfies the threshold probability.

24. The method of claim 21, wherein the indication of the first user selection indicates at least one of a selection of a representation associated with the first application on the screen or execution of the first application.

25. The method of claim 21, wherein the criteria for the second user selection comprises at least one of a time of day, a day of week, a location, a user device service status, a user device movement status, a device platform, or contextual information associated with at least one user of the group of users.

26. The method of claim 25, further comprising:
determining, by the processing hardware, user behavior patterns of at least one user of the group of users with respect to the collection of applications based on the criteria;
determining, by the processing hardware, a probability of the second user selection of a second application of the collection of applications based on the user behavior patterns after receiving the indication of the first user selection of the first application; and
identifying, by the data processing hardware, the second application as a recommended application when the probability of the second user selection of the second application satisfies a probability criterion.

27. The method of claim 26, wherein the user behavior patterns comprise at least one of selecting an application of the collection of applications or performing one or more operations on an application of the collection of applications.

28. The method of claim 26, wherein the user behavior patterns comprise determining user selections of the one or more user selectable links within a threshold period of time, when a user selection rate associated with each user selectable link is within a threshold selection rate, displaying on the screen the user selectable link for each recommendation application.

29. The method of claim 26, further comprising determining the probability of the second user selection of the second application of the collection of applications based on user behavior patterns of at least one user of the group of users.

30. The method of claim 21, further comprising:
receiving, at the data processing hardware, a user selection of one of the one or more user selectable links; and
executing, at the data processing hardware, the application access mechanism associated with the selected user selectable link.
